(19) United States
(12) Patent Application Publication
(10) Pub. No.: US 2021/0253329 A1
(43) Pub. Date: Aug. 19, 2021

(54) MULTI-COMPARTMENT PACKAGE FOR PREPARING TAHINI BASED PRODUCTS AND METHOD OF USING THE SAME

(71) Applicant: Rushdi Food Industries Ltd., Afula (IL)

(72) Inventor: Aref BASHIR, Um El Fahem (IL)

(73) Assignee: Rushdi Food Industries Ltd., Afula (IL)

(21) Appl. No.: 17/308,787

(22) Filed: May 5, 2021

Related U.S. Application Data
(63) Continuation of application No. PCT/IL2020/050141, filed on Feb. 5, 2020.
(60) Provisional application No. 62/813,788, filed on Mar. 5, 2019.

(30) Foreign Application Priority Data
Feb. 7, 2019 (IL) 264737

(51) Int. Cl. B65D 81/32; B65D 85/72; B65D 75/30; B65D 75/58; B65D 75/52; A23L 23/00; A23L 25/00

(52) U.S. Cl. CPC B65D 81/3266; B65D 85/72; B65D 75/30; A23V 2002/00; B65D 75/522; A23L 23/00; A23L 25/30; B65D 75/58

(57) ABSTRACT

A multi-compartment tahini package including a film defining opposed side walls of an enclosure sealed together along its perimeter and at least one rupturable seal dividing the enclosure into at least two sealed compartments, the at least two sealed compartments including, respectively, at least two fluids to be mixed, wherein a first compartment includes a first volume housing an aqueous liquid and a second compartment includes a second volume housing raw tahini having a homogenous particles size with particles size of less than 40 μm and optionally a viscosity of at least 1,000 cps. Also disclosed is a method of producing a ready for use, tahini based liquid product. The method including providing the multi-compartment food package, rupturing the at least one rupturable seal of the enclosure, and mixing content of the at least two compartments to form an edible, ready for use, tahini sauce.

### TECHNOLOGICAL FIELD

The present disclosure relates to multi-compartment tahini packages.

### BACKGROUND ART

References considered to be relevant as background to the presently disclosed subject matter are listed below:
US Patent Application Publication No. US2015043838
US Patent Application Publication No. US2014001065
US Patent Application Publication No. US2012074002
US Patent Application Publication No. US2010151085
US Patent Application Publication No. US2002150658
US Patent Application Publication No. US2001030133
U.S. Pat. No. 6,036,004
U.S. Pat. No. 5,287,961
GB Patent Application Publication No. GB2134067
U.S. Pat. No. 4,145,449
U.S. Pat. No. 3,294,227
U.S. Pat. No. 3,074,544
US Patent Application Publication No. 2005103653
U.S. Pat. No. 9,550,622

Acknowledgement of the above references herein is not to be inferred as meaning that these are in any way relevant to the patentability of the presently disclosed subject matter.

### BACKGROUND

US 2015043838 describes a mixing pouch forming a packaging product that includes a first compartment containing a supply of a liquid ingredient and a second compartment that contains a supply of a powdered ingredient with a breakable seal between the two compartments to separate the two ingredients. Rupturing the breakable seal creates a common interior cavity and allows the mixing of the two ingredients to create a mixed product. One end of the mixing pouch is formed with a dispenser through which the mixed product is dispensed for use.

US 2014001065 describes a container for preparing a multiproduct, which comprises at least two products, one of the products being a first fluid and the other product being a second fluid or a first solid product, the products being arranged in at least two compartments that are separated from one another by means of a seal that is frangible or can rupture under pressure, wherein a predetermined amount of the second fluid or first solid product is housed in one compartment and a predetermined amount of the first fluid is housed in the other compartment.

US 2012074002 describes a package having two or more selectively isolated compartments and a mixing region is disclosed. A mixing region can be included between the mixing compartments, with respective access devices (e.g., zipper or film member) provided to provide selective communication between the compartments and the mixing region.

US 2010151085 describes an assembly for the preparation of an egg-product comprising dried egg and a container which is designed to house said dried egg until it is to be used. The container consists of a bag comprising at least two compartments which are separated from one another by means of a pressure-breakable welded seam. One of the compartments houses a pre-determined quantity of dried egg, while the other compartment houses a pre-determined quantity of water.

US 2002150658 describes a consumer packaged food articles fabricated from a flexible film comprise at least two compartments or chambers containing different food components isolated from each other by an intermediate partition or seal that prevents mixing of the contents of the compartments or chambers prior to purchase by the consumer. The package is constructed to permit mixing of the two components in the package by the consumer prior to consumption of the mixed product.

US 2001030133 describes a packaging bag made of a synthetic resin film, wherein a layer constituting an inner surface is formed of a blend of straight-chain low-density polyethylene resin and polybutene-1 resin, and an internal space of the packaging bag is partitioned by a partitioning heat sealed portion that is parallel with opposite heat sealed portions perpendicular to a film flowing direction and which is narrower than the opposite heat sealed portions, thereby forming a plurality of housing spaces.

U.S. Pat. No. 6,036,004 describes a multi-compartment bag which provides two substances separated until their desired intermixing. A specific application of this multi-compartment bag is for hot or cold chemical packs. The substances in the multi-compartment bag are separated by two breakable walls and a third compartment which together act as a barrier to migration of one substance into the second substance.

U.S. Pat. No. 5,287,961 describes a multi-compartment package made from flexible thermoplastic material heat sealed at the peripheral edge, the compartments being formed by rupturable partition strips heat sealed in place between the sheets of thermoplastic material forming the package.

GB 2134067 describes a flexible peripherally sealed plural compartment package including at least three compartments one of which is a mixing compartment.

U.S. Pat. No. 4,145,449 describes a multi-compartment package for the packaging of food products takes the form of a generally flat rectangular pouch-like package which is permanently closed at the side edges, has a temporary seal at the top edge and a bottom closure. A further temporary seal extends between the top and bottom of the package separating the interior of the package into two separate compartments. The package is opened by separation along the temporary seals to result in a one compartment package open at the top.

U.S. Pat. No. 3,294,227 describes a compartmented package adapted to hold and mix a plurality of components and having at least two adjacent compartments of which one is adapted to hold a liquid. The package comprises a flexible bag having two opposed, similarly shaped outer walls secured to each other to form between them an interior space within the bag; and rupturable barrier means between and secured to the two outer walls to divide the interior space into two separate compartments.

U.S. Pat. No. 3,074,544 describes a package seam as applied to a two-compartment package in which the seam has to be readily rupturable to permit mixing of the compartment contents prior to opening the package by, say, cutting off a corner.

US 2005103653 describes a multicompartment device suitable for preparing a spreadable oil and water emulsion, the device comprising at least two compartments, separated by at least partially removable separation means, wherein one compartment comprises at least one aqueous phase and another compartment comprises at least one oil phase. Removal of the separation means enables mixing of the ingredients of the at least two compartments to form a spreadable oil and water emulsion.

U.S. Pat. No. 9,550,622 describes a filled package for the preparation of a foamed beverage or food product from a liquid primary ingredient and air, the package comprising at least one wall defining a chamber containing the primary ingredient, an outlet for dispensing the foamed beverage or the prepared product and an air inlet for selectively enabling the ingress of air into the chamber, wherein the air inlet comprises a one way valve in the at least one wall, wherein the package is resiliently deformable between an initial compressed position in which air is substantially evacuated from the package and an expanded position, such that when the ingress of air is enabled the package recovers from the compressed position to the expanded position sucking air into the chamber thereby mixing with the primary ingredient.

### General Description

The present invention provides a multi-compartment tahini package suitable for the formation of tahini sauce. The package comprises a first compartment comprising an aqueous liquid and a second compartment comprising fine raw tahini and a rupturable seal dividing the two compartments.

It has been found that when using in the multi-compartment package (i) fine raw tahini that is characterized, inter alia, by a homogenous particles size distribution and an average particle size of less than 40 μm and (ii) a headspace volume in at least one if not both the compartments, it is possible to form a smooth/homogenous tahini sauce without the formation of undesired agglomerates, once the two fluids (the aqueous liquid and the raw tahini) are mixed.

Thus, in accordance with a first of its aspects, the present disclosure provides a multi-compartment tahini package comprising a film defining opposed side walls of an enclosure sealed together along its perimeter and at least one rupturable seal dividing the enclosure into at least two sealed compartments, the at least two sealed compartments comprising, respectively, at least two fluids to be mixed,

wherein a first compartment comprises a first volume housing an aqueous liquid and a second compartment comprises a second volume housing fine raw tahini, the fine raw tahini having a homogenous particles size distribution with an average particle size of less than 40 μm.

Also provided by the present disclosure is a method of preparing a ready for use tahini product, the method comprises providing a multi-compartment tahini package as disclosed herein, rupturing the at least one rupturable seal of said enclosure, and mixing content of the at least two compartments to form a homogenous ready for use tahini product.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1C are images of two different packages (FIGS. 1A-1B, first package, FIG. 1C second package) in accordance with two non-limiting embodiments of the present disclosure.

FIG. 2 is an images of package in accordance with yet another non-limiting embodiment of the present disclosure.

FIG. 3 is a schematic illustration of a unit for manufacturing a food package according to one non-limiting embodiment of the present disclosure.

FIG. 4A-4B are optical microscope images of raw tahini having a homogenous size distribution and an average size of less than 40 μm (FIG. 4A) and of raw tahini having an average size greater than 50 μm (FIG. 4B).

FIGS. 5A-5C are images of a fine raw tahini package before mixing the liquids within the compartments (FIG. 5B), after mixing (FIG. 5A) and the resulting homogenous, ready to use tahini product (FIG. 5C)

FIGS. 6A-6C are images of a reference raw tahini package before mixing the liquids within the compartments (FIG. 6A), after mixing (FIG. 6B) and the resulting in a diluted tahini containing liquid and an agglomerated tahini mass remaining in the package (FIG. 6C).

### DETAILED DESCRIPTION

The present invention is based on the development of a package suitable for the preparation of a single dose, ready for use, tahini product. The package is a multi-compartment package comprising a film defining opposed side walls of an enclosure sealed together along its perimeter and at least one rupturable seal, for example, transverse seal, dividing the enclosure into at least two sealed compartments, the at least two sealed compartments comprising, respectively, at least two fluids to be mixed,

wherein a first compartment comprises a first volume housing an aqueous liquid and a second compartment comprises a second volume housing fine raw tahini, the fine raw tahini being characterized by at least one of, preferably both a homogenous particles size distribution and an average particle size of less than 40 μm.

As appreciated, when brought into contact with water, any raw tahini is susceptible of microbial development and contamination. Thus, it is essential that raw tahini is kept at minimal moisture content and is formed into an edible product by mixing with water, only prior to consumption. Thus, the package disclosed herein was found to be of particular relevance when raw tahini is held in one of the package's compartments while the aqueous liquid (water, citrus juice etc.,) is maintained in one other compartment. Thus, not only the low microbial count of the raw tahini is maintained, the consumer is provided with the amount of aqueous liquid required in order to effectively mix the ingredients into a homogenous, ready to use, tahini paste or sauce and thus avoiding the cumbersome agglomeration and clumps formation in the edible product.

It has been found that when using fine raw tahini (raw tahini having a homogenous particle size of below 40 μm) it is possible to easily form a smooth “ready for use” tahini product, once the aqueous liquid, e.g. water, and the fine raw tahini are homogenously mixed.

When referring to “raw tahini” it is to be understood as meaning ground sesame seeds without the addition of external water. In other words, the raw tahini contains at least 98% sesame seeds material, i.e. at least 98%, at times, at least 99% and further at times 100% of only the sesame seeds material.

Sesame seeds are well known in the art as the seeds of the sesame plant (Sesamum indicum or benniseed). The seeds are characterized as being rich in oil, proteins, carbohydrates, fibre, minerals and vitamins and are widely used in the food industry. Sesame seeds are ovate, slightly flattened and have a weight of between 20 and 40 milligrams. Their colors vary throughout the different available varieties, including off-white, buff, tan, gold, brown, reddish, gray and black.

The sesame seeds from which the raw food product can be produced are, in accordance with some examples, mature seeds, namely, seeds that have reached their full maturity. Maturity of seeds is understood by those versed in the art. For example, Growers Guides [Sesaco, Sesame Coordinators by D. Ray Langham, Jerry Riney, Glenn Smith, and Terry Wiemers March 2008] define the following phases and stages of sesame growing, including the stage of maturation.

The raw tahini comprises the ground roasted (hulled or non-hulled) sesame seed particles dispersed in sesame oil that is derived from the seeds during the process of production of the raw product. Thus, the raw tahini is a fluid product.

Ground hulled sesame seeds are typically obtained by first soaking hulled sesame seeds in water and then crushing to separate the bran from the kernels. The crushed seeds are soaked in salt water, causing the bran to sink. The floating kernels are skimmed off the surface, roasted, and ground to produce an oily paste comprising sesame oil and cell debris (the latter corresponding to the particulated carbohydrates) which together constitute raw tahini.

When referring to roasted sesame seeds it is to be equivalently regarded as roasted seeds with the meaning of being subjected to controlled heating at temperatures of less than 100° C., at time, less than 80° C., less than 70° C., less than 60° C., or even less than 50° C. that while being browned, the seeds are not burnt.

When referring to “ready for use” tahini it is to be understood as meaning raw tahini after being diluted with another aqueous based fluid such as water, lemon juice or the like.

When referring to “fine raw tahini” it is to be understood as meaning raw tahini that has a homogenous size distribution and/or an average particle size below 40 μm.

In some examples, the fine raw tahini comprises microparticles of the ground roasted sesame seeds. The overall grinding (including milling and/or crushing) is conducted to obtain particles of essentially uniform size (e.g. a single peak in a Size Distribution Curve, SDC), having an average size of not more than 50 μm, at times, not more than 40 μm, at times not more than 30 μm, at times between 5 μm to 40 μm, at times between Sum to 40 μm, at times between 5 μm to 30 μm, at times, between 15 μm to 40 μm, at times, between 10 μm to 40 μm.

In some examples, the fine raw tahini has an essentially symmetrical peak in the SDC. In some examples, the fine raw tahini is of a type where in a SDC, all mean value (average), median value (the value where half of the population resides above this point, and half resides below this point) and mode value (the highest peak seen in the distribution) are essentially identical (±10% deviation).

In some examples, the fine raw tahini has a narrow distribution width in a SDC with any one of D10 is between 1 μm to 10 μm, at times between 1 μm to 5 μm, D50 is between 10 μm to 30 μm, or between 20 μm to 40 μm, D90 is between 40 μm to 50 μm or even D90=40 μm. In some examples, D50 is between 20-40 μm.

In some cases, the particles of the fine raw tahini have a size distribution span (Span=(D90−D10)/D50) of between 5 μm to 30 μm or between 5 μm to 25 μm

A unique feature of the fine raw tahini incorporated within the package disclosed herein is that it is stable during storage, namely it is maintained, within the package, as a single homogenous phase, without any visible showing of oiling of processes. As appreciated, “oiling off” concerns the uncontrolled separation of oil out of the sesame protein material, as occurs also with cheese, halva etc., a phenomena that deteriorates the quality of the food product in time. Such phase separated in raw tahini is often considered by consumers as damaged, spoiled and having low quality raw tahini. As such, incorporating fine raw tahini that is devoid of or has minimal oiling off, into the multi-compartment package disclosed herein is advantageous.

In addition or alternatively, the term stable in connection with the present disclosure denotes that the fine raw tahini maintains a homogeneous uniform fluid phase. In other words, in time there is essentially no separation into two immiscible layers.

Stability in the context of the present disclosure is determined following the product storage. In some embodiments, the product described herein is stable for at least 1 month when stored at room temperature, at times for at least 2 month, at times for at least 3 month, at times for at least 4 month, at times for at least 5 month, at times for at least 6 month, at times for at least 8 month, at times for at least 12 month.

Further characteristics of the fine raw tahini incorporated within the multi-compartment package disclosed herein relate to its ability to hold water when mixed with an aqueous liquid. It has been found that the raw tahini having a homogenous particles size distribution with a particle size of less than 40 nm, at times less than even 30 nm or between about 5 nm to 30 nm is capable of holding an amount of water that is greater than the amount of water held by raw Tahini of other size distribution (e.g. having a particle size greater than 50 nm and/or non-homogenous size distribution), and thus swiftly forms into a smooth tahini paste, once the seal of the multi-compartment package is ruptured and the content of the compartments are mixed.

In some examples, it has been found that the fine raw tahini within the package is of a type capable of holding at least 10% w/w, at times, at least 20%, or at least 30% more water than a raw tahini having a particle size greater than 50 nm and/or a non-symmetrical and/or non homogenous size distribution. The ability of the fine raw tahini within the package is crucial in order to form homogenous and uniform tahini sauce once mixed with the aqueous liquid. “Holding” thus should be understood to refer to the capability of the fine raw tahini within the package of being mixed with water and yet being maintained as a single phase, i.e. without breaking. A “broken” tahini is one where, upon mixing with water, the protein containing matter therein agglomerates or aggregates in the fluid oily medium and this agglomeration is visible to the eye (see in this connection the non-limiting comparative examples).

In some additional or other examples, the fine raw tahini within the package is characterized as being thixotropic.

Thixotropy denotes the behavior of the tahini upon sheering, i.e. it's viscosity decreases over time while being subjected to shearing forces, while after a time period in rest state (i.e. no stress applied), the material returns completely to its original viscosity.

In some examples, the fine raw tahini is characterized by a viscosity (at rest state, i.e. before applying any shear forces or mixing that would change the viscosity of the tahini) of at least 750 cps, at times at least 1,000 cps, at times, at least 1,500 cps, at times, at least 2,000 cps, at times, at least 2,500 cps, at times, even at least 3,000 cps, or even at least 3,500 cps.

The result of having a fine raw tahini that has at least one of (i) a uniform particle size and (ii) viscosity of at least 1,000 cps, at times, at least 1,500 cps, at times, at least 2,000 cps, at times, at least 2,500 cps, at times, even at least 3,000 cps allowed the long term storage of the tahini in the multi-compartment package and upon easy and quick mixing provide a ready for use tahini that is smooth and homogenous in texture. In some cases, the fine raw tahini, suitable for packaging within the package disclosed herein, is one characterized by the herein defined uniform size and the herein defined viscosity both contributing together to the stability of the raw tahini, namely, being maintained as a single liquid phase, when stored within the package, at room temperature and for a time period of at least six months, and to its ease of mixing it with aqueous medium.

Without being bound by theory, it is believed that the gentle processing of the sesame seeds with several batch milling stages and the least damage to the protein structure provides fine raw tahini with less denatured protein matter and higher water holding capacity, the latter contributing to the stability of the tahini within the package.

Some fine raw tahini that can be incorporated in the multi-compartment package disclosed herein and the manner of its preparation is described in WO2016/207887, the content of which is incorporated herein by reference.

The package disclosed herein is configured to store, separately, the fine raw tahini as defined herein and the aqueous medium, such that upon their mixing together, a ready for use tahini product is prepared.

The multi-compartment food package that includes at least two compartments which may be the same or different in their internal volume, as will be discussed below.

The package can include more than one rupturable seal, thus dividing the package into more than two compartments. Thus, each compartment may have one, two or several neighboring compartments, each being separated from at least one neighbor compartment by a rupturable seal.

The compartments in the package comprise at least fine raw tahini and at least an aqueous liquid. The compartments may include other fluids to be mixed upon rupturing o the rupturable seal.

For the purpose of the present disclosure the term “fluids” denotes any edible fluid substance. This includes liquids, semi-liquids (e.g. pastes), powders and gaseous material.

Generally, raw tahini includes particulated carbohydrates and/or particulate proteinous material that are hydrophilic in nature and thus upon mixing with the aqueous liquid, agglomeration of the particulated matter takes place, at times to an extent where a solid mass or lumps are formed within the oil matter making it difficult to further mixing it into an edible form.

Yet, it has been found and now disclosed that the use of fine raw tahini as defined herein with a headspace volume within the package, allows the easy mixing of the fine raw tahini with water while within the package, whereby a homogenous final product (lacking lumps or agglomerates visible to the eye) is formed.

For the purpose of the present disclosure, the term “headspace volume” denotes a volume within the enclosure other than that occupied by the edible liquids or other edible matter within the enclosure. In some examples, the headspace volume comprises or is filled with a gaseous material, e.g. air, oxygen or an inert gas such as nitrogen.

In some examples, the headspace volume is contained within one of the compartments of the multi-compartment raw tahini package. In some other examples, the headspace volume is divided (not necessarily equally) between the compartments of the multi-compartment package.

The headspace volume should be sufficient to facilitate mixing of the content of the compartments into a homogenous edible ready for use tahini product. In fact, it has been found that due to the nature of raw tahini that tend to agglomerate upon contact with water, without a sufficient headspace volume, the formation of a homogenous fluid is either almost impossible or is laboring, and in accordance with some examples, even when using fine raw tahini of the type described herein.

In some examples, the headspace volume constitutes at least 10%, at times, at least 11%, 12%, 13%, 14%, 15%, 16%, 17%, 18%, 19% or even at times, at least 20%, further at times at least 25% or any value above 10% or above 16% or above 20% out of the total volume formed within the walls of the enclosure, i.e. of the total volume of all compartments together.

In some examples, the headspace volume constitutes between 15% to 25% out of the total volume formed within the walls of the enclosure.

In some examples, the headspace volume constitutes between 18% to 22% out of the total volume formed within the walls of the enclosure

The volume of the headspace volume may be determined in a non-compressed state of the all compartments in the multi-compartment package, in Standard Temperature and Pressure (STP) conditions, namely when no external force is applied on the compartments and the ambient conditions of the food package are about the STP conditions. Alternatively, the headspace volume may be defined as the volume that is matching for an amount of uncompressible liquid.

The volume ratio between the aqueous liquid and the fine raw tahini may vary depending on the desired texture of the resulting edible ready for use tahini product.

In some examples, the volume of the edible fine raw tahini is lower than the volume of the aqueous liquid.

In some examples, the volume of the edible fine raw tahini is about the same as the volume of the aqueous liquid

In some examples, the volume of the edible fine raw tahini is greater than the volume of the aqueous liquid.

In some examples, the volume ratio between the aqueous liquid and edible fine raw tahini (including the particulated matter, e.g. carbohydrates) is 1:1 to 2, at times 1:1.1, at times 1:1.2, at times 1:1.3, at times 1:1.4, at times 1:1.5 and at times even up to two volumes of the edible fine raw tahini per one volume of the aqueous liquid.

In some examples, the volume ratio between the edible fine raw tahini (including the particulated carbohydrates) and the aqueous liquid is 1:1 to 2, at times 1:1.1, at times 1:1.2, at times 1:1.3, at times 1:1.4, at times 1:1.5 and at times even up to two volumes of the aqueous liquid per one volume of the edible raw tahini.

The aqueous liquid and the edible fine raw tahini may each be distributed between several compartments or each may be contained in a single compartment.

The aqueous liquid may be water. Yet, in accordance with some examples, the aqueous liquid is a water based liquid. This may include any liquid food ingredient, including, without being limited thereto, citrus juice, vinegar, soy sauce, etc.

The mixing of the content of the compartments is facilitated by the rupturing of the rupturable seal or seals.

In some examples, the rupturable seal is a transverse seal as illustrated in some non-limiting examples provided hereinbelow.

In some examples, the rupturable seal is configured to be ruptured upon application of force. Thus, when such a force is applied on the walls of the enclosure, the rupturable seal is ruptured and the content of the compartments is allowed to be come into contact. The rupturable seal and the sealing of the walls at the perimeter of the enclosure can be obtained by any means known in the art.

In some examples, the sealing is provided by thermos-sealing techniques (thermoseal or heat-welding seal). In some other embodiments, the sealing is provided by ultrasonic techniques (ultrasonic seal or ultrasonic welding seal).

The sealing of the rupturable seal and the sealing of the walls do not need to be made by the same technique. Yet, the sealing of the rupturable seal must be weaker than that to the walls of the enclosures, to ensure that upon application of the pressure onto the enclosure, only the rupturable seal opens. In other words, the sealing of the walls at the perimeter of the enclosure is of resistance to rupture that is greater than that of the at least one rupturable seal.

In some examples, the rupturable seal is ruptured by rubbing of or applying friction on the walls of the enclosure, one against the other.

In some examples, the rupturable seal is a pressure breakable seam.

In some examples, each wall of the enclosure comprises a pulling member, e.g. pull tabs, for grasping and pulling apart the walls of the enclosure to cause opening of the rupturable seal.

With respect to the sealing of the walls at the perimeter of the enclosure, it is to be noted that the perimeter of the enclosure does not necessarily mean the outmost ends/edges of the film forming the walls. At times, the sealing is distanced from the edges of the film, forming two flanking walls surrounding the enclosure.

In some examples, the film or at least a portion thereof is formed by at least one sheet of flexible material, such that the walls of the enclosure and thus the volume within the compartments can be deformed.

In some examples, the film is formed of a food compatible material. For example, the film may be formed of a food compatible plastic material.

Without being limited thereto, the film comprises or is formed of multi layers.

In some examples, the film is a multilayer laminated film selected from the group consisting of polyethylene (PE)/polyethylene terephthalate Metalized (PETM)/polyethylene terephthalate (PET), PE/aluminum (AL)/PET; PE/PET,

In some further examples, the film is a multilayer film selected from PE/ethylene vinyl alcohol (EVOH)/polyamide (PA) and PE/PA,

In some examples, the film is composed of two or more different layers attached to one another around.

In some examples, at least a portion of the film is transparent to allow visualization of content of at least a portion of content of the package. This may allow to verify the state of the content before opening the package, after mixing the content of the compartments etc.

In some examples, the package may be completely opaque or otherwise non-transparent.

In some examples, the food package includes a dispensing end formed by a tear-away portion. The tear-away portion is integrated with the walls of at least one compartment of the enclosure such that when tearing away the wall portion, the content of the compartment or of the entire enclosure (e.g. after mixing) is free to be dispensed.

The walls of the enclosure may be defined as having an inner surface (facing the internal volume of the enclosure) and an outer surface.

In accordance with some examples, to facilitate mixing, and in accordance with some examples, at least a portion of the inner surface of the walls comprises abutments extending inwardly. It has been envisages that such abutments may reduce agglomeration and lump formation of the particulated carbohydrates including proteinous material when brought into contact and mixed with the aqueous liquid.

Specifically, and without being bound thereto, the abutments provide mechanical friction assisting in the breaking of the agglomerates, thereby facilitating the formation of a smooth and homogenous edible ready for use tahini product.

For the purpose of the present disclosure, when referring to “abutments” it is to be understood as any slight physical deviation (typically in micrometer scale) from the surface of the wall. The abutment may be in the form of In some embodiments, the abutments are in the form of rails, dimples, corrugations, ripples or any other form of roughness on the inner surface of the wall. The abutment may be a combination of different forms of physical deviations such as any combination of the above.

The package disclosed herein can be obtained by known techniques, including vertical packaging machines as well as horizontal packaging machines.

The package should not be limited to a specific dimension. When the package is used for preparing a single dose of ready for use tahini (e.g. tahini sauce) the dimensions may be configured to provide a volume of ready for use tahini in the range of 5 ml to 20 ml, at times between 10 ml to 20 ml, at times between 5 ml to 15 ml. Yet the package can be configured to provide larger volumes of ready to use tahini without undue experimentations.

In some cases, the package is designed to be in a rectangle, double sachet form, with easy peal partition between the two compartments and a width and a length, each independently in the range of between 30 mm-200 mm, at times between 40 mm to 150 mm.

The disclosed package provides a solution for preparing a ready to use edible tahini product which is known to be difficult to mixed and/or require specific ingredients ratio and mixing conditions so as to form therefore a smooth paste or sauce. One unique feature of the package disclosed herein is that the volume of the aqueous liquid and the volume edible raw tahini holding the particulate carbohydrates including proteinous material is a priori selected to allow, in the presence of the pre-determined minimal headspace volume, simple and quick (e.g. less than a minute) mixing of the ingredients within the enclosure and only when mixing is compete (e.g. a homogenous liquid is visualized), dispensing the content of the package. As noted above, at least the raw tahini is selected to have a homogenous size distribution (single narrow peak in a SDC) and an average size of less than 40 μm, both as defined herein (referred to herein as a “fine raw tahini”) and preferably also a thixotropic behavior with a viscosity of at least 1,000 cps, all as defined hereinabove.

It is important to note that the package disclosed herein is not suitable for any raw tahini and as shown in the non-limiting examples, when using raw tahini of a size greater than 50 μm, the tahini aggregates and it is impossible to mix it with water to obtain a smooth tahini sauce.

The present disclosure also provided a method of preparing a ready for use edible tahini product, the method comprises providing a multi-compartment food package as disclosed herein, rupturing the at least one rupturable seal of the enclosure that separates the content of the compartments, and mixing the contents of the compartments to form the edible ready for use fluid tahini product.

In accordance with the method disclosed herein, since the package includes raw tahini with the unique characteristics defined herein, the method is also unique in that it allows the formation of a smooth and homogeneous tahini sauce within very few seconds of mixing after the seal is ruptured. In some examples, the homogenous tahini product (tahini and water mixture) is ready, without visible lumps and/or differences in mixture color, within less than 20 seconds from bringing the water an raw tahini into contact (e.g. mixing), at times, less than 15 seconds from beginning of mixing or even less than 10 seconds from beginning of mixing.

In some examples, the mixing involves shaking the mixed contents. In some other examples, mixing involves rubbing the walls of the enclosure.

It is to be noted that the term “about”, when referring to a value, means that there is a tolerance with respect to the nominal value of 20%. For example, about 30% should be referred as 24-36%.

### DETAILED DESCRIPTION OF EMBODIMENTS

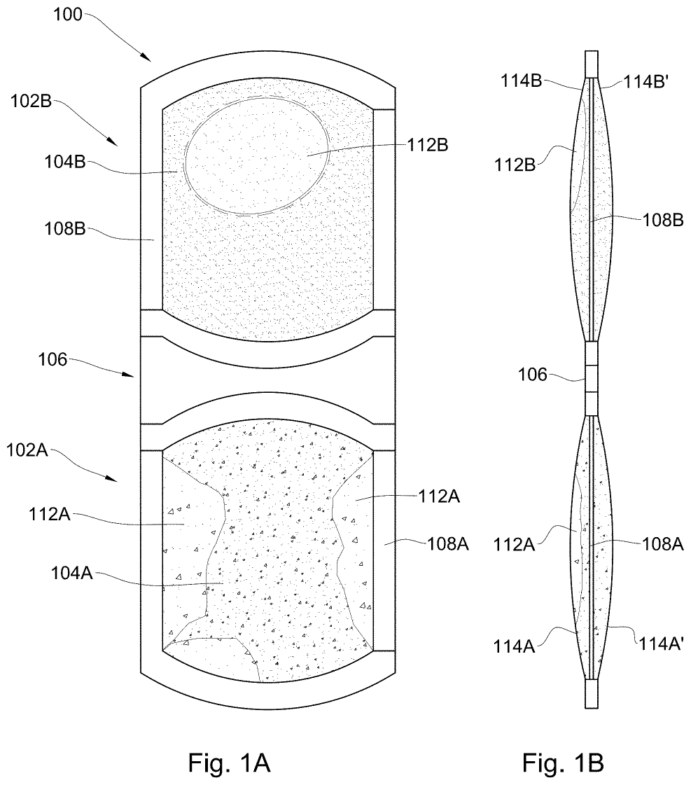

Reference is now being made to FIGS. 1A-1C which provide images of non-limiting examples of food packages in accordance with some embodiments of the present disclosure.

FIGS. 1A-1B are, respectively, top and side view schematic illustrations of a a food package 100 in accordance with one embodiment of the present disclosure. Food package 100 includes a first compartment 102A and second compartments 102B. First compartment 102A comprises a first fluid food ingredient 104A which is in this non-limiting example, water, and second compartment 102B comprises a second fluid raw tahini ingredient 104B (ground hulled sesame seeds).

First compartment 102A and second compartment 102B are separated from each other by an hermetic yet rupturable seal section 106.

The rupturable seal 106 is a heat-welding seal. Yet, as detailed above, the seal may be provided by other techniques.

Size and shape of the first compartment 102A and second compartment 102B are define, respectively, by a welded edge 108A of the first compartment 102A and edge 108B of the second compartment 102B, which are, in this essentially the same as the size and contour 108A of the second compartment 102A.

In FIG. 1C, the size of the first compartment 102A is smaller than the size of the second compartment 102B. In addition, compartment 102B has a contour 108A that has a trimmed portion 110A. This trimmed portion may be configured as a tear-away portion (not specifically illustrated), for dispensing therethrough the edible food after being mixed within the enclosure.

Each compartment also includes a headspace volume 112A and 112B. The headspace volume 112A and 112B is a volume which is essentially free of the fluid food ingredients and may include gas, e.g. air, inert gas, etc., or may be a substantially vacuumed volume.

The rupturable seal may be formed from a single transverse sealing thread, such as rupturable seal 106 that is illustrated in FIG. 1C or may be formed from two transverse sealing threads as illustrated in FIG. 1A-1B.

Compartments 102A and 102B are formed from two opposite facing films 114A and 114A′ and 114B and 114W, where films 114A and 114B are transparent, thus showing the content of the compartment, while films 114A′ and 114W are made of aluminum foil, which is non-transparent.

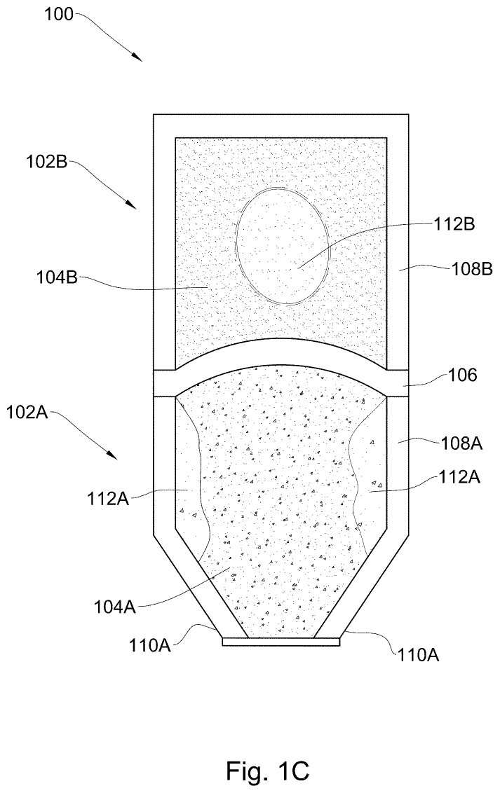

FIG. 2 provides an image of a package in accordance with yet another embodiment of the present disclosure. For simplicity, reference numerals of elements of FIG. 1A-1C are shifted by 100 for elements in FIG. 2 that serve the same function. Thus, for example, package 100 in FIG. 1A-1C is represented as package 200 in FIG. 2.

Specifically, package 200 is equipped with a dispensing arrangement 220 equipped with a screw type cap, for dispensing therethrough the mixed edible product.

The dispensing arrangement 220 is controllable between a closed state and an open state that permits dispensing of the edible product from enclosure. The transition between the a closed and open state may be irreversible or in some embodiments, the dispensing arrangement may be configured to allow repeated transitions from a closed to open state.

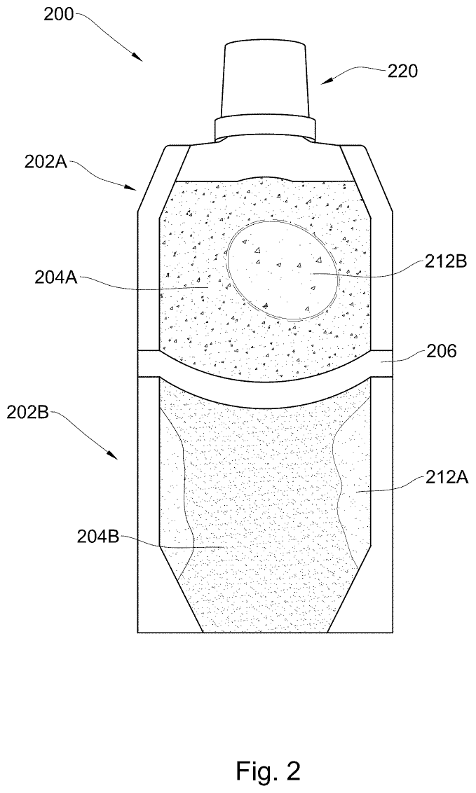

The package can be manufactured by any technique known in the packaging industry. Yet, FIG. 3 provides a schematic illustration of a non-limiting example of a packaging unit 330 for manufacturing a food package according to some embodiments of the present disclosure.

For simplicity, reference numerals of elements of FIG. 1A are shifted by 200 for elements in FIG. 3 that serve the same function. Thus, for example, film 114A in FIG. 1A is represented as film 314A in FIG. 3

Packaging unit 350 comprises a conveyer (not illustrated) through which two elongated, parallel facing films 314A and 314B, are transferred (alternatively, a single elongated film that is folded along its center). Along the conveyer there are three sequential heat welding units, including a first welding unit 354 for longitudinally heat-sealing the two parallel films along their longitudinal edges 354A and 354B, a second welding unit 356 for introducing a median seal 356A forming an (easy peel/rupturable) partition between two compartments of the packages, illustrated as compartment 302A and 302B. Welding unit 356 is configures to produce a seal that is less resistant to rupture (easy peel) than longitudinal heat-sealed edges 354A and 354B, the median seal 356A constitute the rupturable seal described hereinabove; and a third welding unit 358 for introducing a segmenting seal 358A that defines the division of the elongated and films into the individual packages 300A, 300B, 300C etc. Segmenting seal 358A is formed and designed such to allow a cut along the seal so as to physically separate between the packages after completion of the manufacturing process.

Packaging unit 350 also includes two feed pipe, a first fluid feed pipe 360 and a second fluid feed pipe 362. Feed pipes 360 and 362 are configured such that in operation, each pipe feeds fluid into a compartment formed by welding unit 356 while the longitudinal films are conveyed within the unit and thereafter the compartments are sealed by welding unit 358.

In operation, the two elongate films 314A and 314B (or the single folder film) are conveyed through the packaging unit 350 in a generally continuous manner, with pausing events to allow the effective welding and feeding of the thus created compartments. From third welding unit 358 an elongated strip 380 of filled packages connected to each other along the segmenting seal 354A exists. This elongated strip 380 can then be cut along segmenting seal 358A into individual packages (not illustrated).

### Some Non-Limiting Examples

### Determining Particles Size

“Package raw tahini” (i.e. the raw tahini to be packaged) was prepared as described in WO 2016/207887. This tahini is also commercially available under the brand name Baracke 100% Tahini (Baracke, Israel). As a reference raw tahini a commercially available product having a greater particle size was used. This reference raw tahini was prepared by a single step milling of hulled and roasted sesame seeds until reaching particles size that are between 50 μm to 100 μm. In the following description and non-limiting examples, the term “reference raw tahini” denotes raw tahini fluid prepared by a single milling stage and/or that has a particle size greater than 50 μm. Further, in the present description the term “fine raw tahini” denotes one that has a homogenous size distribution and a particle size of less than 40 μm or even less than 30 μm, as further defined herein and preferably also a viscosity above 1,000 cps, or even above 2,000 cps as defined herein.

Generally, the package raw tahini was prepared using an Ethiopian line of sesame seeds (Sesamum Indicum, Ethiopian Withish seeds, Humera type, Certificate of Ethiopian Chamber of Commerce and Sectorial Association No. 156295) characterized by a characterized by a weight of 20 mg to 40 mg and dimensions: length between 3 mm to 4 mm, width 2 mm and thickness 1 mm, 4-6% moisture, 50-57% fat and 22-27% protein.

Inter alia, the seeds were sifted using a 1-1.2 mm sifter and the sifted seeds were then continuously washed with water to remove pesticides and the like, and then suspended in clean water for 20 to 30 minutes. The soaked seeds where then pealed in a wet-pealing process during which separation between the seed coat (bran, hull) and the kernel was achieved. De-coating was conducted by gentle mixing in a blender at a spin rate of 170 rpm to 220 rpm (without applying pressure on the seeds, to avoid breaking of the seeds), while maintaining the moisture of the seeds in the range of 39%-46%.

The de-coated kernels were roasted, using a steam oven, at a temperature around 120° C. During the roasting period samples of kernels are extracted in hexane to verify quality of the kernels and in particular, protein content and quality. The moisture of the roasted kernels at the end of the process was determined to be about 1.5%.

The kernels were then cooled to a temperature of 20° C.-30° C. Residual hull were removed by sifting the roasted kernels. The kernels had an average size of 210 μM which are then transferred to the milling stage.

The kernels were collected and initially ground to obtain particles of average size known in the industry, and then further ground in two sequential ball mills (total passing through a ball mill of about 4-8 times or more), maintained at a temperature of 30° C.-80° C. in accordance with the process steps illustrated in FIGS. 1 and 2 of WO2016/207887, the content of which is incorporated herein by reference.

Overall, the kernels were passed through at least four ball mills and possibly more. After the first ball mill, the average size of the crushed kernels was about 120 μm; after a second ball mill the crushed product had an average size of about 80 μm; after the third ball mill the crushed product had an average size of 40 μm and after the fourth ball mill the crushed kernels has an average size of 25 μm. Further milling can satisfy reaching even smaller size particles of less than 25 μm or even less than 20 μm, e.g. between 5 μm to 30 μm or even between 5 μm to 15 μm, so as to improve the stability of the raw tahini.

The resulting product was a smooth and stable raw tahini product.

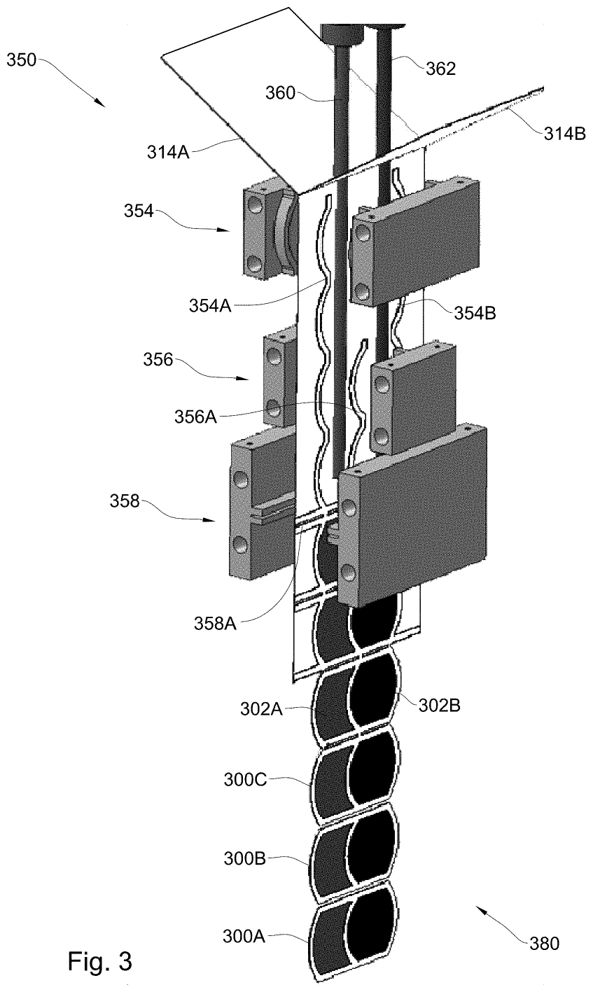

The fine raw tahini and the reference raw tahini were imaged using an optical microscope under ×400 magnifications, as shown in FIGS. 4A and 4B respectively. Specifically, FIG. 4A shows that the particles of the fine raw tahini used in the multi-compartment package of the present disclosure have much smaller sizes and a narrow size distribution as compared to that of the reference raw tahini (FIG. 4B) with extreme differences in the sizes of the particles (2 extremities circled).

The average size of the particles was determined based on optical microscope images of the two examined materials. FIG. 4A shows particles of the fine raw tahini forming part of the package of the present disclosure while FIG. 4B show particles of, raw tahini prepared by conventional techniques.

Quantitative analysis of the two images (scale at left bottom corner being 100 μm) resulted in the determination that the particles of FIG. 4B have particles size of more than 50 μm and specifically between 50 and 100 μm while the fine raw tahini used in accordance with the present disclosure and shown in FIG. 4A, has an essentially homogeneous size distribution of the particles (i.e. narrow size distribution of the particles) with a size that is less than 40 μm or even less than 30 μm and specifically between 5 to 30 μm.

### Determining Headspace Volume

For determining the minimal headspace volume in a two compartment package containing raw tahini and water, the following experiments were conducted:

In a series of two compartment packages as illustrated in FIG. 1A two equal volumes (5 ml) of water and sesame paste (tahini) were separately enclosed. Each package included a different headspace volume, as shown in Table 1. The headspace volume was divided between the two compartments. After rupturing of the seal and a mixing time of 8 seconds, the level of mixing of the content of the two compartments, the quality of the mixed product was evaluated. The results are presented in Table 1.

TABLE 1
effect of headspace volume on mixed product quality

| Headspace | |
|---|---|
| volume | Quality of mixing |
| 5% | The mixed content was not homogenous, included left oil residue and |
| | did not reach a desired consistency and uniformity in terms of color |
| | and texture (thickness). To obtain a desired texture (homogenous, |
| | smooth liquid) further mixing time was required. |
| 15% | The mixed content was not homogenous, included left oil residue and |
| | did not reach a desired consistency and uniformity in terms of color |
| | and texture (thickness). To obtain a desired texture (homogenous, |
| | smooth liquid) further mixing time was required. |
| 20% | A homogenous mixture was obtained with no residual oil. In addition, |
| | the mixture had a consistent color and texture (thickness) |
| 30% | A homogenous mixture was obtained with no residual oil. In addition, |
| | the mixture had a consistent color and texture (thickness) |

In a further experiment, the effect of the volume of the headspace on the mixing of raw tahini within a two compartment package such as that illustrated in FIG. 1A was examined. Specifically, raw tahini having homogenous particles size with particles size of less than 40 μm with headspace volumes from 10% to 20% (out of the total volume of the two compartments) was packed in a two compartment packages, each compartment including 10 ml liquid (raw tahini or water) and the indicated headspace volume. The mixing time until obtaining a smooth (lump-free) spread was examined, and the results are presented in Table 2.

TABLE 2
effect of headspace volume on mixing time of raw tahini and water

| Headspace | Mixing | |
|---|---|---|
| % | time (s) | Comments |
| 10 | 15 | The mixture contained a significant amount of |
| | | agglomerates |
| 15 | 10 | The mixture contained some level of |
| | | agglomerates (less than that with 10% |
| | | headspace volume) |
| 20 | 6-8 | Mixing was quick, provided a homogenous |
| | | mixture with no visible lumps or agglomerates |
| | | in the resulting paste. |

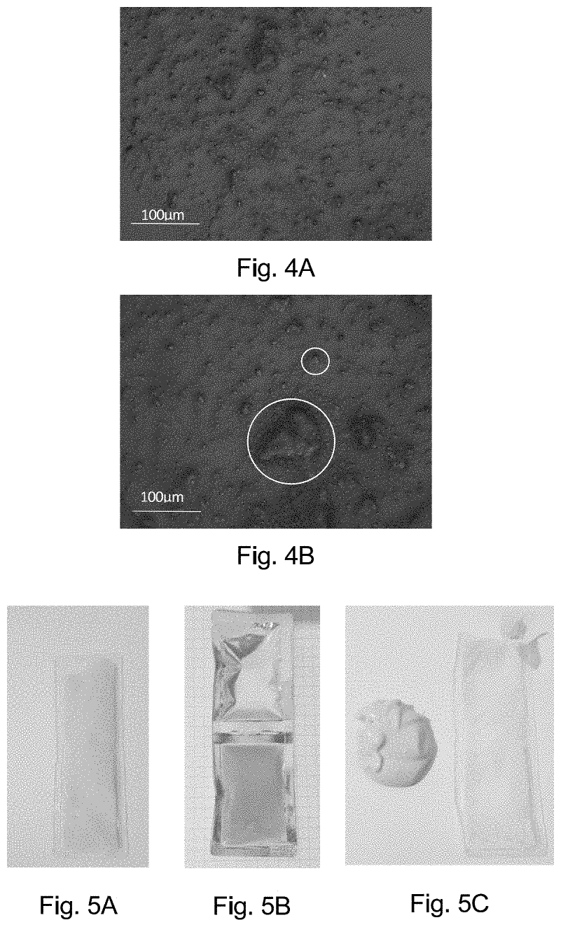

FIGS. 5A-5C provide images of the two-compartment package containing 20% headspace volume before rupturing the seal (FIG. 5B), after mixing for 6-8 seconds (FIG. 5A) and of the homogenous ready for use tahini product after being extracted from the package (FIG. 5C). FIGS. 5A-5C show that the resulting mixture provides a smooth product with no proteinous lumps visible to the eye.

In comparison, the Reference Raw Tahini was packed in the same two compartment package with the same headspace volumes, and mixing time was examined, the results of which are presented in Table 3:

TABLE 3
effect of headspace volume on mixing time
of Reference Raw Tahini and water

| Headspace | Mixing | |
|---|---|---|
| % | time (s) | Comments |
| 10 | 25 | The mixture contained a significant amount of |
| 15 | 25 | agglomerates and could not reach a |
| 20 | 25 | homogenous mixture or a desired viscosity |

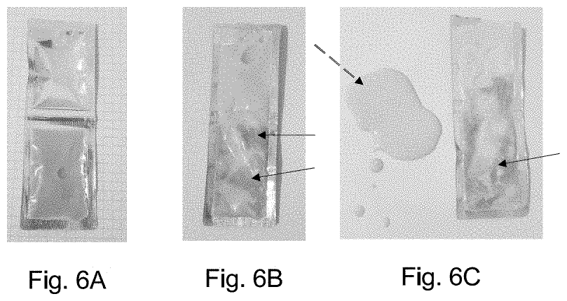

The results show that when using raw tahini that is not homogenous in size and has particles size greater than 50 μm, it is almost impossible to get a smooth, homogenous mixture of the water and raw tahini. This finding is also exhibited in FIGS. 6A-6C where a package with the Reference Raw Tahini (FIG. 6A) is ruptured and the two liquid are immiscible, leaving lumps of proteinous material (indicated by the arrows). When expelled from the package, most of the raw tahini remains in the package with only a very diluted/watery (low viscosity) tahini being retrieved (FIG. 6C, indicated by dashed arrow). It was further noted that during storage, the packages containing the Reference Raw tahini exhibited a degree of oiling off within the compartment containing the reference raw tahini, a phenomena that did not take place in the packages with the product raw tahini even after a period of 6 months storage (not shown).

1. A multi-compartment tahini package comprising a film defining opposed side-walls of an enclosure sealed together along its perimeter and at least one rupturable seal dividing the enclosure into at least two sealed compartments, the at least two sealed compartments comprising, respectively, at least two fluids to be mixed,
wherein a first compartment comprises a first volume housing an aqueous liquid and a second compartment comprises a second volume housing raw tahini having a homogenous particles size with particles size of less than 40 μm.

2. The multi-compartment tahini package of claim 1, comprising raw tahini having a viscosity at rest of at least 1,000 cps.

3. The multi-compartment tahini package of claim 1 comprising raw tahini having particles size of less than 30 μm and a viscosity of at least 2,500 cps.

4. The multi-compartment tahini package of claim 1, comprising a total volume including said first volume, said second volume and a headspace volume, the volume of the headspace is that is at least 10% out of the total volume of the enclosure.

5. (canceled)

6. The multi-compartment tahini package of claim 1, wherein said raw tahini has particles with a size distribution appearing as single peak in a size distribution curve.

7. The multi compartment tahini package of claim 6, wherein said single peak is an essentially symmetrical peak.

8. The multi-compartment tahini package of claim 1, wherein the rupturable seal is configured to be ruptured upon application of force onto at least a portion of the walls.

9. The multi-compartment tahini package of claim 1, wherein the film is formed by at least one sheet of flexible material.

10. (canceled)

11. The multi-compartment tahini package of claim 1, wherein the walls of the enclosure are sealed at their entire perimeter.

12. The multi-compartment tahini package of claim 1, comprising a dispensing end formed by a tear-away portion, the dispensing end configured for expelling content out of the enclosure.

13. (canceled)

14. The multi-compartment tahini package of claim 1, wherein at least a portion of the film is transparent to allow visualization of content of at least a portion of said enclosure.

15. The multi-compartment tahini package of claim 1, wherein the film comprises an inner surface facing at least a portion of the first volume and second volume, said inner surface comprises abutments extending inwardly or the inner surface of the film is roughened, so as to facilitate mixing of the at least two liquids after rupture of the rupturable seal.

16. A method of preparing a ready for use tahini product, the method comprises providing a multi-compartment tahini package of claim 1, rupturing the at least one rupturable seal of said enclosure, and mixing content of the at least two compartments to form an edible fluid tahini product.

17. (canceled)

18. (canceled)

19. A multi-compartment tahini package for use in the formation of tahini sauce, comprising at least one first compartment comprising an aqueous liquid and at least one second compartment comprising fine raw tahini and a rupturable seal dividing the two compartments; wherein said package comprises a headspace volume that constitutes at least 10% out of the total volume of all compartments together.

20. The multi-compartment tahini package of claim 19, wherein said fine raw tahini has a homogenous particles size of less than 40 μm.

21. A method of preparing a ready for use tahini product, the method comprises providing a multi-compartment tahini package of claim 19, rupturing said rupturable seal, and mixing content of the compartments to an edible fluid tahini product.
